(19) United States
(12) Patent Application Publication
(10) Pub. No.: US 2016/0341150 A1
(43) Pub. Date: Nov. 24, 2016

(54) Thrust Reverser System and Method with Flow Separation-Inhibiting Blades

(71) Applicant: The Boeing Company, Chicago, IL (US)

(72) Inventors: Chen Chuck, Mercer Island, WA (US); Hin-Fan M. Lau, Redmond, WA (US)

(21) Appl. No.: 14/718,241

(22) Filed: May 21, 2015

(51) Int. Cl. F02K 1/72; F02K 1/76

(52) U.S. Cl. CPC F02K 1/72; F02K 1/76

(57) ABSTRACT

An aircraft thrust reverser system including a fan duct including a bullnose, a cascade positioned to direct air outward from the fan duct to generate reverse thrust with respect to a direction of travel, and a flow separation-inhibiting blade positioned within the fan duct proximate the bullnose, wherein the flow separation-inhibiting blade directs the air toward the cascade.

### FIELD

This application relates to aircraft engines and, more particularly, to aircraft thrust reversers.

### BACKGROUND

Various commercial and non-commercial aircraft deploy a thrust reverser, in some form, immediately after touchdown. A typical thrust reverser blocks forward thrust or redirects forward thrust into a form of reverse thrust. Therefore, thrust reversers convert a portion of forward thrust generated by an aircraft engine into reverse thrust, thereby decreasing the speed of the aircraft when landing.

During thrust reverser landings, the reversed air flow is complicated with effluxes pointing at various directions. The area around the bullnose of the nacelle often experiences flow separation due to adverse pressure gradients. The flow separation can lead to ineffective flow through the thrust reverser cascade and, thus, insufficient reverse thrust.

The reverse thrust lost due to flow separation has caused aerospace engineers to extend the length of the nacelle and the thrust reverser cascade to accommodate for the flow separation. However, such modifications increase the overall weight of the aircraft and, thus, negatively impact the fuel efficiency of the aircraft.

Accordingly, those skilled in the art continue with research and development efforts in the field of aircraft thrust reversers.

### SUMMARY

In one embodiment, the disclosed aircraft thrust reverser system may include a fan duct including a bullnose, a cascade positioned to direct air outward from the fan duct to generate reverse thrust with respect to a direction of travel, and a flow separation-inhibiting blade positioned within the fan duct proximate the bullnose, wherein the flow separation-inhibiting blade directs the air toward the cascade.

In one embodiment, the disclosed aircraft thrust reverser method may include the steps of (1) exposing a cascade; (2) positioning a flow separation-inhibiting blade proximate a bullnose upstream of the cascade; and (3) directing an airflow across the flow separation-inhibiting blade and to the cascade.

Other embodiments of the disclosed thrust reverser system and method will become apparent from the following detailed description, the accompanying drawings and the appended claims.

### BRIEF DESCRIPTION OF THE DRAWINGS

FIG. 1 is a cross section view of an aircraft engine including one embodiment of the disclosed thrust reverser system with flow separation-inhibiting blades;

FIG. 2 is a cross section view of a portion of the aircraft engine of FIG. 1, with the flow separation-inhibiting blades in a retracted position;

FIG. 3 is a cross section view of a portion of the aircraft engine of FIG. 1, with the flow separation-inhibiting blades in an extended position;

FIG. 4 is an enlarged view of the portion of the aircraft engine shown in FIG. 3;

FIG. 5 is an enlarged view of the flow separation-inhibiting blades shown in FIG. 3;

FIG. 6 is a cross section view of an aircraft engine including an alternate embodiment of the disclosed thrust reverser system with flow separation-inhibiting blades

FIG. 7 is a flowchart representative one embodiment of the disclosed thrust reverser method.

### DETAILED DESCRIPTION

The disclosed thrust reverser system includes flow separation-inhibiting blades for use during thrust reverser operation at landing to improve airplane performance. The flow separation-inhibiting blades may be positioned proximate (at or near) the curvature or contour of the bullnose. As used herein, “bullnose” (also called a diverter fairing) refers to the sharply curved portion of the fan duct immediately prior or upstream from the thrust reverser cascade. The flow separation-inhibiting blades are positioned just upstream of the cascade to provide better flow alignment and favorable pressure gradient, thereby reducing (if not eliminating) flow separation at the bullnose.

The curvature of the bullnose causes air to flow much quicker near the bullnose than it flows in the rest of the nacelle. This higher speed air develops a lower pressure, which leads to a drastic pressure differential between the air flowing near the bullnose and the air further away from the bullnose. This differential leads to airflow separation near the bullnose as the air enters the cascade. Because of this separation, the vanes of the cascade that are positioned closer to the bullnose are essentially clogged with slow moving air, effectively removing those cascade vanes from providing reverse thrust. (As used herein, the cascade vane nearest the bullnose will be referred to as the “first” or “front” vane, the next vane will be referred to as the “second” vane, etc. and the vanes furthest from the bullnose will be referred to as the “last” or “far” vanes.) In other words, the first and second vanes are often rendered useless, or nearly useless, in reverse thrust operations. To account for such clogging of the front vanes, additional vanes are added to the far vanes to make up for the lost reverse thrust. For example, if a cascade design originally consists of 13 or 14 cascade vanes, the first and second vanes provide practically no thrust. Therefore, additional vanes (e.g., fifteenth and sixteenth vanes) are often added to make up for the lack of thrust provided by the first and second vanes. Adding the disclosed flow separation-inhibiting blades improves air flow to the first and second cascade vanes, thus improving reverse thrust from the cascade.

Computational fluid dynamics (CFD) analysis validates this concept. Preliminary CFD analysis of a typical thrust reverser cascade shows an approximately 6 percent increase in fan mass flow rate of the reversed fan flow through the same cascade with the flow separation-inhibiting blades installed and strategically located proximate the bullnose, as disclosed herein. The introduction of the disclosed flow separation-inhibiting blades can result in up to, it is believed, approximately 15 percent more reverse thrust from the same cascade, as compared to a bullnose without the disclosed flow separation-inhibiting blades, and/or an approximately ⅛th reduction in thrust reverser cascade length, and/or an approximately 3 percent reduction in nacelle length (due to the need for fewer cascade vanes). Returning to the example discussed above, this reduction comes by eliminating the need for the 15^{th} and 16^{th} cascade reverser vanes since the first and second vanes would perform as intended. Therefore, introducing the disclosed flow separation-inhibiting blades proximate the bullnose may reduce (if not eliminate) flow separation due to the adverse pressure gradient associated with the bullnose and, as such, may maximize thrust reverser performance.

The increased performance provided by the disclosed flow separation-inhibiting blades may lead to a significant reduction in the weight and the length of the nacelle (e.g., about 150 pounds/engine). Those skilled in the art will appreciate that a reduction in overall aircraft weight by several hundred pounds may improve fuel economy and/or increase cargo capacity.

As used herein, a “direction of travel” refers to an intended or designed direction in which an engine is to cause a platform to move in a forward mode of operation. Reference to a “direction of travel” is relative to the engine, relates to actual or intended movement and, thus, does not require actual movement or travel of the engine. Furthermore, as used herein, a position “forward” of a reference in the direction of travel refers to a position that, when traveling in the designated direction of travel, will reach a given plane perpendicular to the direction of travel prior to the reference. Conversely, as used herein, a position “following” or behind a reference in the direction of travel refers to a position that, when traveling in the designated direction of travel, will reach a given plane perpendicular to the direction of travel subsequent to the reference.

Because the bullnose can reduce the effectiveness of one or more vanes of a thrust reverse cascade, in some examples disclosed herein, extendable/retractable flow separation-inhibiting blades are positioned along the path of airflow near or adjacent to the bullnose of a nacelle during thrust reverser operation to reduce flow separation. The exact number of flow separation-inhibiting blades is not critical. There can be as few as a single flow separation-inhibiting blade, or as many as seven or more. For one example aircraft engine, the optimal number may be six, grouped in three pairs of two, with a pair closest to the bullnose, and a pair farther from the bullnose. However, those skilled in the art will appreciate that the optimal number of flow separation-inhibiting blades, as well as the optimal arrangement of flow separation-inhibiting blades, will depend on various factors, including the overall size of the associated aircraft engine.

The flow separation-inhibiting blades may be substantially parallel with the bullnose surface, and may have a contour closely corresponding to the curvature of the bullnose. The exact dimensions of the flow separation-inhibiting blades are not critical. The dimensions can range in length from about 2 inches to about 20 inches, can have a thickness less than about ¼ inch, and can be located a distance of between about 0.1 inches to about 5 inches from the surface of the bullnose. As used herein, the “length” of a flow separation-inhibiting blade refers to a measurement taken from the end farthest from the cascade to the opposite end, closest to the cascade. For one example aircraft engine, the optimal flow separation-inhibiting blade length is about 4 inches to about 15 inches, such as about 6 inches to about 12 inches; the optimal distance from the bullnose is about 0.25 inches to about 2.5 inches, such as about 0.5 inches to about 1.5 inches, with any additional blades spaced further from the bullnose; and a blade thickness of less than ¼ inch. The width of the flow separation-inhibiting blades may be approximately the same as the width of the vanes of the associated cascade. The width could be greater or less, so long as the flow separation-inhibiting blade reduces or eliminates air flow separation at the bullnose.

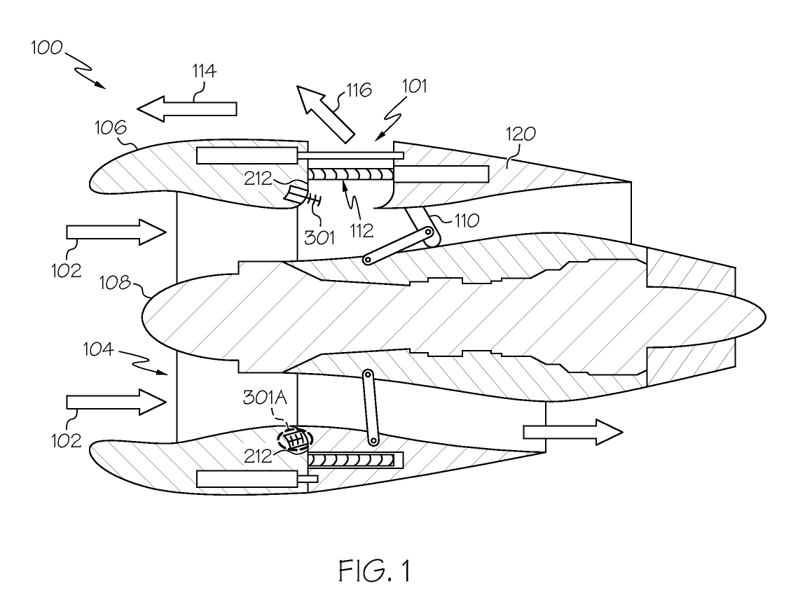

Referring to FIG. 1, one embodiment of the disclosed aircraft engine, generally designated 100, may include a cascade thrust reverser 101. The aircraft engine 100 may be a turbofan engine that can generate reverse thrust 114 to more rapidly slow down the associated aircraft (not shown). The aircraft engine 100 intakes an airflow 102 via a fan inlet 104. The airflow 102 is urged through a nacelle 106 that contains a turbine assembly 108.

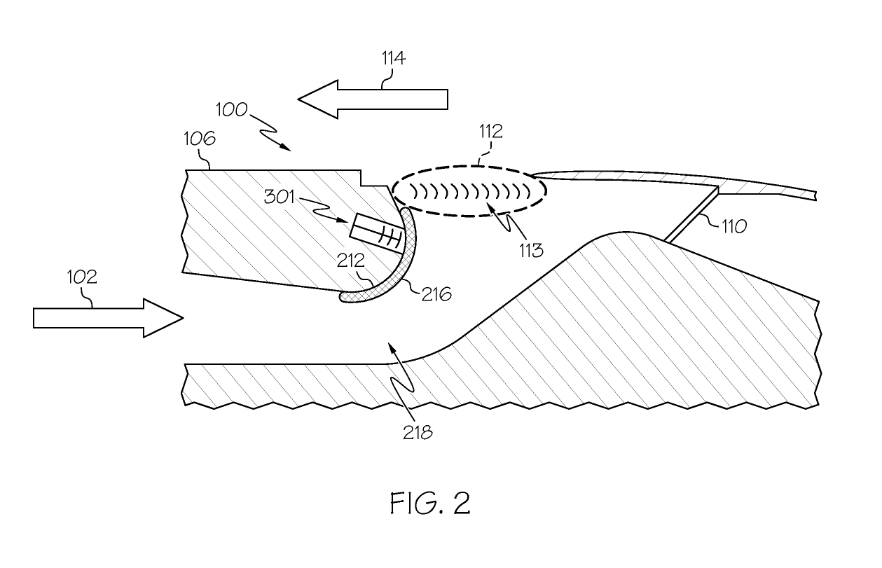

The cascade thrust reverser 101 may include a blocking door 110 and a cascade 112. The cascade 112 includes a plurality of cascade vanes 113 (FIG. 2). During thrust reversal, instead of being ejected from the rear of the aircraft engine 100 to generate forward thrust, the airflow 102 is blocked by the blocking door 110 and directed by the cascade 112 as an outward airflow 116. The outward airflow 116 generates the reverse thrust 114.

Therefore, the cascade thrust reverser 101 generates reverse thrust 114 by directing the intake airflow 102 through the cascade 112. As the intake airflow 102 is directed through the cascade 112 to produce the outward airflow 116, the airflow 102 flows over a bullnose 212.

Referring to FIG. 2, one or more (two are shown in FIG. 2) flow separation-inhibiting blades 301 may be contained within (e.g., retracted or otherwise withdrawn within) the bullnose 212. As such, a region 216 directly adjacent the bullnose 212 may experience an increase in airflow speed and a resulting decrease in air pressure relative to the airflow 102 in the remainder of the fan duct 218. Without being limited to any particular theory, it is believed that the region 216 causes a decrease in flow speed, and a corresponding increase in pressure, of air approaching the region 216. As the air in the region 216 approaches the cascade 112, the air experiences an adverse pressure gradient (e.g., rising pressure). Due to the adverse pressure gradient, the air approaching the cascade 112 may separate from the bullnose 212. This separation results in a reduction in air flow across the front-most vane 113 (or the front-most vanes 113) of the cascade 112 and, as such, reduces the effectiveness of the cascade 112.

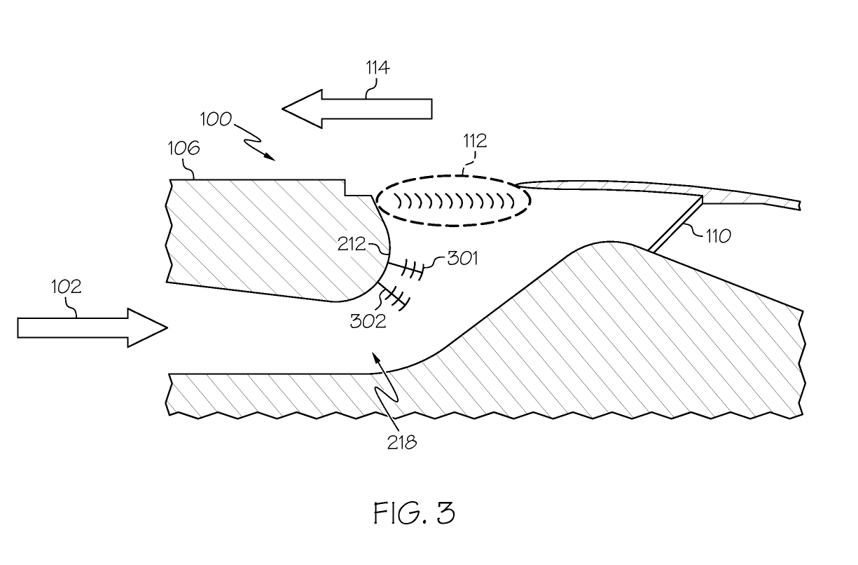

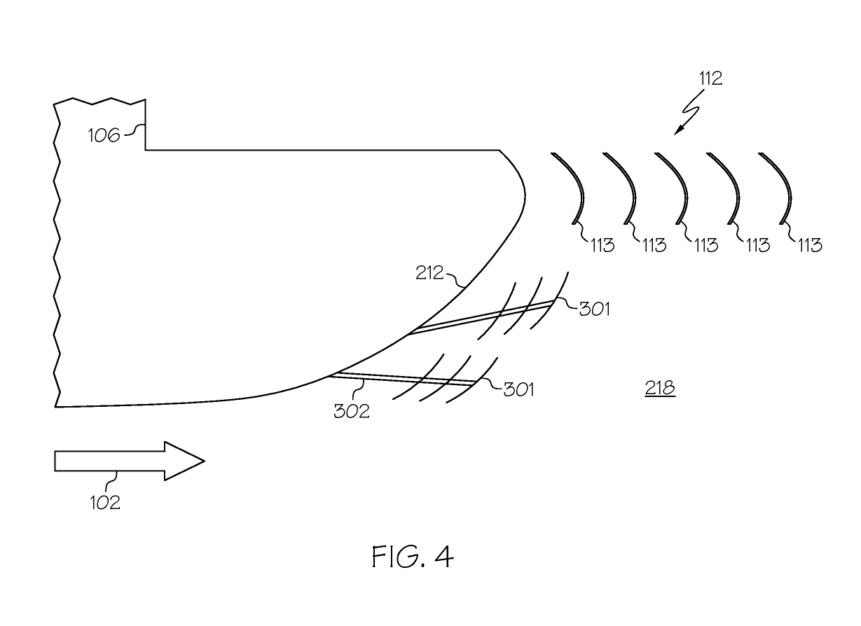

Referring to FIGS. 3 and 4, the deployed or extended flow separation-inhibiting blades 301 may be located proximate the bullnose 212 to direct airflow 102 in the region 216 (FIG. 2) and maintain a uniform, or nearly uniform, airflow 102 throughout the fan duct 218. The airflow 102 directed by the flow separation-inhibiting blades 301 may reduce or eliminate flow separation within the region 216 (FIG. 2), which may result in a more uniform airflow 102 through the cascade 112. Therefore, the cascade 112 may be rendered more effective in providing reverse thrust 114 (FIG. 3).

As noted above, the exact number of flow separation-inhibiting blades 301 is not critical. FIG. 3 shows an embodiment that includes two flow separation-inhibiting blades 301 on a support arm 302, with two support arms 302 present, thereby providing a total of four flow separation-inhibiting blades 301. FIG. 4 shows an alternative embodiment that includes three flow separation-inhibiting blades 301 on a support arm 302, with two support arms 302 present, thereby providing a total of six flow separation-inhibiting blades 301.

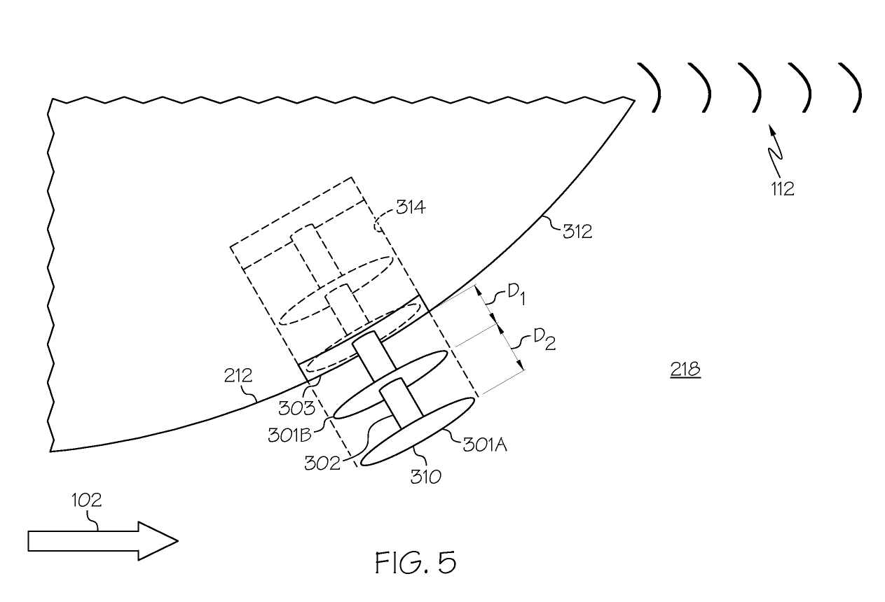

Referring to FIG. 5, in one implementation, the flow separation-inhibiting blades 301 (consisting of blade 301A and 301B in FIG. 5) may be extended from, and retracted into, the bullnose 212 by way of an associated support arm 302. In the retracted position, the outer surface 310 of the outermost flow separation-inhibiting blade 301A may be substantially flush with, and may act as a continuation of, the surface 312 of the bullnose 212, as shown in phantom in FIG. 5.

Still referring to FIG. 5, in the extended position, the flow separation-inhibiting blades 301A, 301B may be spaced away from the surface 312 of the bull nose 212. The proximal flow separation-inhibiting blade 301B may be spaced a distance D₁ from the surface 312 of the bull nose 212. The distance D₁ may be a design consideration, and may depend on the size of the aircraft engine 100 (FIG. 1), among other possible factors. In one expression, the distance D₁ may range from about from to about 0.1 inches to about 5 inches. In another expression, the distance D₁ may range from about from to about 0.25 inches to about 2.5 inches. In yet another expression, the distance D₁ may range from about from to about 0.5 inches to about 1.5 inches. The distal flow separation-inhibiting blade 301A may be spaced a distance D₂ from the proximal flow separation-inhibiting blade 301A. The distance D₂ may be the same as, or similar to, the distance D₁. In one expression, the distance D₂ may be about 80 percent to about 120 percent of the distance D₁. In another expression, the distance D₂ may be about 90 percent to about 110 percent of the distance D₁. In yet another expression, the distance D₂ may be about 95 percent to about 105 percent of the distance D₁.

Optionally, a plug 303 may be connected to the support arm 302 supporting the flow separation-inhibiting blades 301A, 301B. When the flow separation-inhibiting blades 301A, 301B are in the extended position, the plug 303 may fill the resulting opening 314 in the bullnose 212. The plug 303 may be contoured to correspond to the contour of the surface 312 of the bullnose 212, thereby maintaining the integrity of the surface 312 of the bullnose 212 until the flow separation-inhibiting blades 301A, 301B are retracted back into the opening 314.

An extension mechanism may be used to extend and retract the flow separation-inhibiting blades 301. As one specific, non-limiting example, the extension mechanism may include an actuator connected to the support arm 302. The actuator of the extension mechanism may be extendable as needed, such as by hydraulic pressure, pneumatic pressure, electricity of the like. As another specific, non-limiting example, the extension mechanism may include a spring (or other biasing element) connected to the support arm 302. The spring may be compressed (e.g., by a force supplied by the nacelle sleeve 120 shown in FIG. 1) when the flow separation-inhibiting blades 301A, 301B are retracted into the opening 314 in the bullnose 212. Then, when the nacelle sleeve 120 is moved to expose the cascade 112, the force may be removed, thereby allowing the spring of the extension mechanism to urge the flow separation-inhibiting blades 301A, 301B to the extended position. As yet another specific, non-limiting example, the extension mechanism may include a scissor extender, similar to that in a scissor lift.

As an alternative to using an extension mechanism, a biasing element (e.g., a spring) may be connected to the support arm 302 to bias the flow separation-inhibiting blades 301A, 301B into the opening 314 in the bullnose 212. However, the airflow 102 passing through the nacelle 106 (e.g., when the cascade 112 is exposed) may act on the flow separation-inhibiting blades 301A, 301B to overcome the biasing force of the biasing element, thereby drawing the flow separation-inhibiting blades 301A, 301B out of the opening 314 and to the extended position. The flow separation-inhibiting blades 301A, 301B may be returned to the retracted position when the cascade 112 is covered because with the cascade 112 cover the airflow 102 acting on the flow separation-inhibiting blades 301A, 301B is not sufficient to overcome the biasing force.

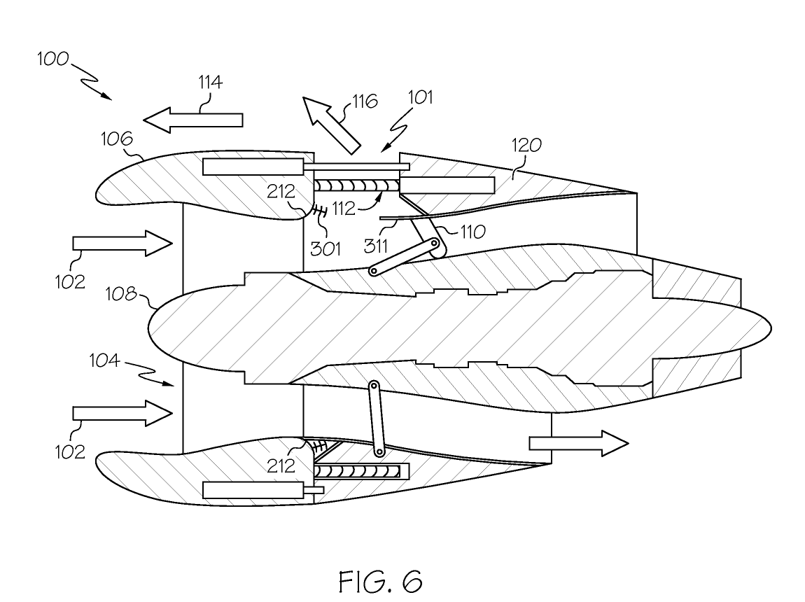

Referring to FIG. 6, in another implementation, the flow separation-inhibiting blades 301 may be static (they do not extend and retract, such as from an opening). In flight, the flow separation-inhibiting blades 301 may be covered, such as by way of a blade sheath 311 associated with the nacelle sleeve 120. During thrust reverser operations, when the cascade 112 is uncovered by the nacelle sleeve 120, the blade sheath 311 is withdrawn and exposes the flow separation-inhibiting blades 301. Once exposed, the flow separation-inhibiting blades 301 may function as described herein.

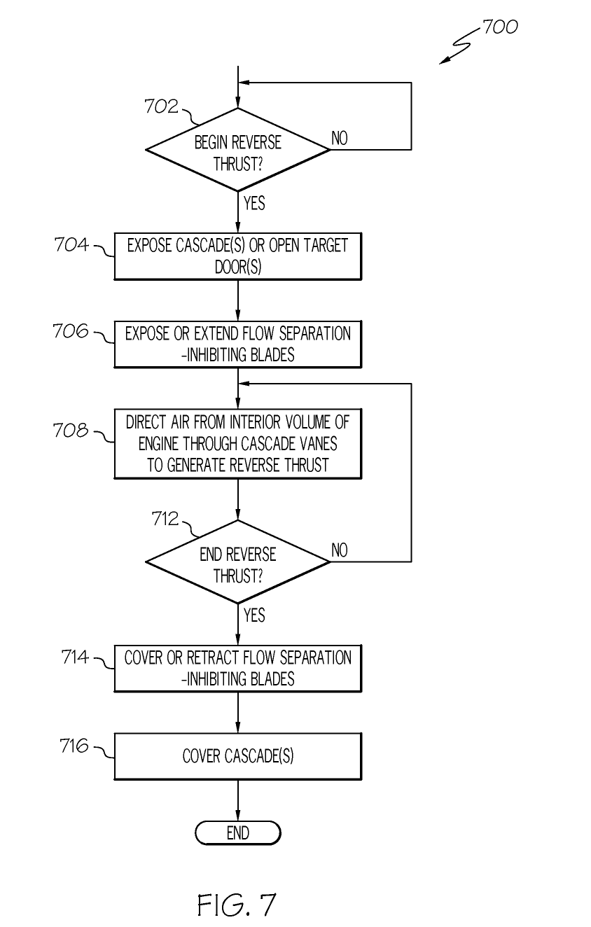

FIG. 7 is a flowchart representative of an example method 700 for generating reverse thrust. The method 700 may begin by determining whether to begin reverse thrust (Block 702). If reverse thrust is not to begin (Block 702), control loops to Block 702 to await the beginning of reverse thrust. When reverse thrust is to begin (Block 702), the method 700 proceeds to Block 704.

At Block 704, the cascade 112 (FIG. 1) may be exposed. For example, the nacelle sleeve 120 (FIG. 1) may be moved to expose the cascade 112. Once the cascade 112 has been exposed, the method 700 may continue to Block 706, where one or more flow separation-inhibiting blades 301 (FIG. 1) may be exposed and/or extended. Upon exposing/extending the flow separation-inhibiting blades 301, airflow 102 (FIG. 1) may be directed to the cascade 112, as shown at Block 708.

At Block 712, the method 700 may determine whether to end reverse thrust. If reverse thrust is to continue (Block 712), the method 700 may return to Block 708 to continue generating reverse thrust. If reverse thrust is to end (Block 712), the method 700 may retract (FIGS. 1-5) or covers (FIG. 6) the flow separation-inhibiting blades 301 (FIG. 1), as shown at Block 714, and may cover the cascade 112 (FIG. 1), as shown at Block 716. The method 700 may then end and/or iterate to generate additional reverse thrust.

Although various embodiments of the disclosed thrust reverser and method have been shown and described, modifications may occur to those skilled in the art upon reading the specification. The present application includes such modifications and is limited only by the scope of the claims.

What is claimed is:

1. An aircraft thrust reverser system comprising:
a fan duct comprising a bullnose;
a cascade positioned to direct air outward from said fan duct to generate reverse thrust with respect to a direction of travel; and
a flow separation-inhibiting blade positioned within said fan duct proximate said bullnose, wherein said flow separation-inhibiting blade directs said air toward said cascade.

2. The aircraft thrust reverser system of claim 1 wherein said bullnose has a surface, and wherein said flow separation-inhibiting blade is substantially parallel with said surface.

3. The aircraft thrust reverser system of claim 1 wherein said bullnose has a curvature, and wherein said flow separation-inhibiting blade has a contour closely correspond to said curvature.

4. The aircraft thrust reverser system of claim 1 wherein said flow separation-inhibiting blade is capable of being deployed and withdrawn.

5. The aircraft thrust reverser system of claim 4 wherein said flow separation-inhibiting blades are deployed and withdrawn via being extended and retracted.

6. The aircraft thrust reverser system of claim 4 wherein said flow separation-inhibiting blades are deployed and withdrawn via being exposed and covered.

7. The aircraft thrust reverser system of claim 1 comprising a plurality of flow separation-inhibiting blades.

8. The aircraft thrust reverser system of claim 7 wherein said plurality of flow separation-inhibiting blades are arranged in a row, said row extending substantially parallel with a surface of said bullnose.

9. The aircraft thrust reverser system of claim 1 further comprising a second flow separation-inhibiting blade, wherein said first flow separation-inhibiting blade is positioned between said bullnose and said second flow separation-inhibiting blade.

10. The aircraft thrust reverser system of claim 1 further comprising an extension mechanism connected to said flow separation-inhibiting blade.

11. The aircraft thrust reverser system of claim 10 wherein said extension mechanism comprises at least one of an actuator and a biasing element.

12. The aircraft thrust reverser system of claim 1 wherein said cascade comprises a plurality of vanes.

13. The aircraft thrust reverser system of claim 1 wherein said flow separation-inhibiting blade has a length ranging from about 2 inches to about 20 inches.

14. The aircraft thrust reverser system of claim 1 wherein said flow separation-inhibiting blade has a thickness of at most about ¼ inch.

15. The aircraft thrust reverser system of claim 1 wherein said bullnose has a surface, and wherein said flow separation-inhibiting blade is spaced about 0.1 inches to 5 inches from said surface.

16. The aircraft thrust reverser system of claim 1 wherein said bullnose has a surface, and wherein said flow separation-inhibiting blade is spaced about 0.25 inches to 2.5 inches from said surface.

17. The aircraft thrust reverser system of claim 16 further comprising a second flow separation-inhibiting blade, wherein said second flow separation-inhibiting blade is spaced about 0.25 inches to 2.5 inches from said first flow separation-inhibiting blade.

18. The aircraft thrust reverser system of claim 1 wherein said flow separation-inhibiting blade is connected to a support arm.

19. A aircraft thrust reverser method comprising:
exposing a cascade;
positioning a flow separation-inhibiting blade proximate a bullnose upstream of said cascade; and
directing an airflow across said flow separation-inhibiting blade and to said cascade.

20. The method of claim 19 wherein a plurality of flow separation-inhibiting blades are positioned proximate said bullnose.
